(19) United States
(12) Patent Application Publication
(10) Pub. No.: US 2025/0320682 A1
(43) Pub. Date: Oct. 16, 2025

(54) GROUND PILE STRUCTURES FOR SOLAR TRACKING SYSTEMS

(71) Applicant: Nextracker LLC, Fremont, CA (US)

(72) Inventors: Alexander W. Au, Oakland, CA (US); Madeleine Davis Kho, Oakland, CA (US); Ricardo Delgado-Nanez, San Jose, CA (US)

(21) Appl. No.: 19/173,978

(22) Filed: Apr. 9, 2025

Related U.S. Application Data
(60) Provisional application No. 63/632,459, filed on Apr. 10, 2024.

(51) Int. Cl. E02D 5/56; H02S 20/10; H02S 20/32

(52) U.S. Cl. CPC E02D 5/56; H02S 20/10; H02S 20/32

(57) ABSTRACT

A ground pile for a solar tracking system includes an elongate hollow tube extending longitudinally from a first end to a second end, a mount proximate the first end for attaching solar tracking components, one or more threaded longitudinal segments of the hollow tube each having exterior helical segments extending around the longitudinal segment and forming a screw thread, and one or more drivable longitudinal segments of the hollow tube having cross-sections with an internal surface shaped in a non-circular shape.

### RELATED APPLICATIONS

This disclosure claims priority to U.S. Provisional Patent Application No. 63/632,459 filed on Apr. 10, 2024, the entire contents of which is hereby incorporated by reference.

### TECHNICAL FIELD

This disclosure relates generally to solar power generation systems, and more particularly, to support structures for solar arrays within a solar tracking system.

### BACKGROUND

One of the most significant, costly, and time-consuming aspects relating to the manufacture and installation of solar trackers is the use of piers to support the solar modules. These piers, typically C-channels, W-beams, I-beams, or the like, are driven deep into the ground using costly heavy machinery such as pile driving equipment or by casting the piers in-situ using costly micro-pile equipment. As can be appreciated, each process not only requires costly equipment, but also requires a significant amount of time to complete, driving up the cost of installing solar tracking systems.

Additionally, solar tracker systems employ a significant amount of bearing housing assemblies, piers, damper assemblies, amongst others. As can be appreciated, the enormous number of these assemblies required to construct a solar tracking system requires a significant amount of material and takes a significant amount of time to install, further driving up the cost of installing solar tracking systems.

In view of these costly processes and designs, solar tracker piers and foundations that alleviate the need for costly and time-consuming processes involving heavy machinery and reduce the amount of material and labor required for installation are needed.

### SUMMARY

In general, the present disclosure relates to support structures for solar arrays within a solar tracking system. In one example, a ground pile for a solar tracking system may include an elongate hollow tube extending longitudinally from a first end to a second end, a mount proximate the first end for attaching solar tracking components, one or more threaded longitudinal segments of the hollow tube each having exterior helical segments extending around the longitudinal segment and forming a screw thread, and one or more drivable longitudinal segments of the hollow tube having cross-sections with an internal surface shaped in a non-circular shape.

Additionally or alternatively, the internal surface of the cross-sections of the one or more drivable longitudinal segments may be polygonal shaped.

Additionally or alternatively, the internal surface of the cross-sections of the one or more drivable longitudinal segments may be adapted to engage with a drive shaft that, when rotated, engages the internal surface and rotates the ground pile.

Additionally or alternatively, two of the one or more the threaded longitudinal segments may be separated longitudinally by one or more of the drivable longitudinal segments.

Additionally or alternatively, the one or more drivable longitudinal segments may not overlap longitudinally with the one or more threaded longitudinal segments.

Additionally or alternatively, the one or more drivable longitudinal segments may overlap longitudinally with the one or more threaded longitudinal segments.

Additionally or alternatively, one or more pushable longitudinal segments of the hollow tube may each taper inward from a wider cross-section to a narrower cross-section in a direction from the first end towards the second end.

Additionally or alternatively, the first end may be open and the second end may be open.

Additionally or alternatively, the first end may be open and the send end may be closed, and wherein a longitudinal segment of the hollow tube tapers inward towards the closed second end.

Additionally or alternatively, an unthreaded longitudinal segment extending from the first end may not have any of the helical segments of the one or more threaded longitudinal segments, the unthreaded longitudinal segment may constitute more than one-fourth of the longitudinal length of the hollow tube.

Additionally or alternatively, the helical segments of the one or more threaded longitudinal segments may be located in only two-thirds of the longitudinal portion of the hollow tube closer to the second end.

Additionally or alternatively, the mount may include a series of holes through the hollow tube.

Additionally or alternatively, the helical segments of the one or more threaded longitudinal segments may be formed by a hydroforming process of a hollow tube.

Additionally or alternatively, the non-circular internal surface of the cross-sections of the one or more drivable longitudinal segments may be formed by a hydroforming process of a hollow tube.

Additionally or alternatively, the one or more drivable longitudinal segments may be formed via welding to a hollow tube.

Additionally or alternatively, the helical segments of the one or more threaded longitudinal segments may form one of sharp threads, buttress threads, or knuckle threads.

In another example, a ground pile for a solar tracking system may include an elongate hollow tube extending longitudinally from a first end to a second end, a mount proximate the first end for attaching solar tracking components, and one or more threaded longitudinal segments of the hollow tube each having exterior helical segments extending around the longitudinal segment and forming a screw thread, the helical segments of the one or more threaded longitudinal segments being formed by a hydroforming process.

In a further example, a ground pile for a solar tracking system may include an elongate hollow tube extending longitudinally from a first end to a second end, a mount proximate the first end for attaching solar tracking components, one or more threaded longitudinal segments of the hollow tube each having exterior helical segments extending around the longitudinal segment and forming a screw thread, and one or more pushable longitudinal segments of the hollow tube each tapering inward from a wider cross-section to a narrower cross-section in a direction from the first end towards the second end.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a front side view of an example ground pile in accordance with the present disclosure;

FIG. 3 is an enlarged view of a first end of the ground pile of FIG. 2, shown in Circle 3;

FIG. 4A is an enlarged view of a threaded longitudinal segment of the ground pile of FIG. 2, shown in Circle 4A;

FIG. 4B is a cross-sectional view of the threaded longitudinal segment of the ground pile as in FIG. 4A;

FIG. 5 is a front side view of an example ground pile in accordance with the present disclosure;

FIG. 6A is an enlarged view of a threaded longitudinal segment of the ground pile of FIG. 5, shown in Circle 6A;

FIG. 6B is a cross-sectional view of the threaded longitudinal segment of the ground pile as in FIG. 6A;

FIG. 7 is a front side view of an example ground pile in accordance with the present disclosure;

FIG. 8A is an enlarged view of a threaded longitudinal segment of the ground pile of FIG. 7, shown in Circle 6A;

FIG. 8B is a cross-sectional view of the threaded longitudinal segment of the ground pile as in FIG. 8A;

FIG. 9 is a front side view of an example ground pile in accordance with the present disclosure;

FIG. 10A is an enlarged view of a threaded longitudinal segment of the ground pile of FIG. 9, shown in Circle 10A;

FIG. 10B is a cross-sectional view of the threaded longitudinal segment of the ground pile as in FIG. 10A;

FIG. 11 is a front side view of an example ground pile in accordance with the present disclosure;

FIG. 12 is a front side view of an example ground pile in accordance with the present disclosure;

FIG. 13 is a front side view of an example ground pile in accordance with the present disclosure;

FIG. 14 is a front side view of an example ground pile in accordance with the present disclosure;

FIG. 15 is a front side view of an example ground pile in accordance with the present disclosure showing a mating feature at a second end of the ground pile;

FIG. 16A is an enlarged view of the mating feature of the ground pile of FIG. 15, shown in Circle 16A;

FIG. 16B is a bottom perspective view of the mating feature as in FIG. 16A;

FIG. 17 is a front side view of an example ground pile in accordance with the present disclosure showing an alternative second end of the ground pile;

FIG. 18A is an enlarged view of the second end of the ground pile of FIG. 17, shown in Circle 18A;

FIG. 18B is a bottom perspective view of the second end of the ground pile as in FIG. 18A;

FIG. 19 is a front side view of an example ground pile in accordance with the present disclosure showing an alternative first end and an alternative second end of the ground pile;

FIG. 20A is an enlarged view of the first end of the ground pile of FIG. 19, shown in Circle 20A;

FIG. 20B is an enlarged view of the second end of the ground pile of FIG. 19, shown in Circle 20B;

FIG. 21 is a front side view of an example ground pile in accordance with the present disclosure;

FIG. 22A is an enlarged view of a threaded longitudinal segment of the ground pile of FIG. 21, shown in Circle 22A;

FIG. 22B is a top perspective view of a first end of the ground pile as in FIG. 21;

FIG. 23 is a front side view of an example ground pile in accordance with the present disclosure;

FIG. 24A is an enlarged view of a threaded longitudinal segment of the ground pile of FIG. 23, shown in Circle 24A; and

FIG. 24B is a top perspective view of a first end of the ground pile as in FIG. 23.

### DETAILED DESCRIPTION

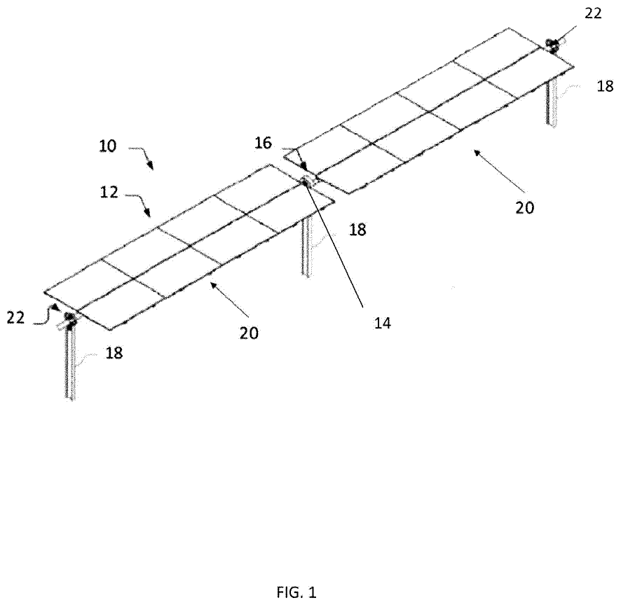

The present disclosure is directed to ground piles for a solar tracking system. FIG. 1 is an elevation view of a common arrangement of a solar tracker 10 provided in accordance with the present disclosure. The solar tracker 10 may be formed of a plurality of bays 20 defined by the distance between ground piles 18 (generally referenced herein as piles 18). FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is just a single drive mechanism 16, the specifications for the torque tube 14 must also seek to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−60 degrees or more).

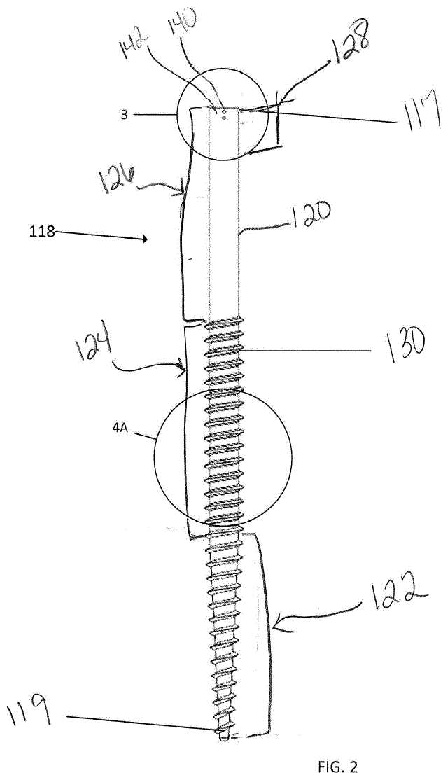

FIG. 2 is a front side view of an example ground pile 118 in accordance with the present disclosure. The pile 118 may be an example of pile 18 as in FIG. 1. As shown in FIG. 2, the pile 118 may include an elongate hollow tube 120 extending longitudinally from a first end 117 to a second end 119. In some cases, the first end 117 of the hollow tube 120 may be open. In some cases, as shown in FIG. 2, the second end 119 of the hollow tube 120 may be closed. A mount 142 may be positioned proximate the first end 117. In some cases, as shown in FIG. 2, the mount 142 may include a series of one or more mounting holes 140 that extend through the hollow tube 120. The pile 118 may be formed from aluminum, brass, carbon, stainless steel, copper, or other metal alloys. To the extent the pile 118 is formed via a hydroforming process, as described herein, the pile 118 may be formed of a material and a thickness appropriate for forming the particular longitudinal segments described herein.

As shown in FIG. 2, the pile 118 may include one or more threaded longitudinal segments of the hollow tube 120 each having exterior helical segments 130 extending around the longitudinal segments and forming a screw thread. The helical segments 130 of the one or more threaded longitudinal segments of the hollow tube 120 may be located in only two-thirds of the longitudinal portion of the hollow tube 120 closer to the second end 119. In some cases, helical segments 130 of the one or more threaded longitudinal segments of the hollow tube 120 maybe located in one-third, one-half, or any other suitable area of the longitudinal portion of the hollow tube 120. As shown, the one or more threaded longitudinal segments may include a first threaded longitudinal segment 122 and a second threaded longitudinal segment 124. The first threaded longitudinal segment 122 of the hollow tube 120 may taper inward towards the closed second end 119. While it is shown that there are two threaded longitudinal segments, it will be appreciated that there may be three longitudinal segments, four threaded longitudinal segments, six threaded longitudinal segments, eight threaded longitudinal segments, or any other suitable number of threaded longitudinal segments as desired.

The first threaded longitudinal segment 122 and the second threaded longitudinal segment 124 may be formed by a hydroforming process of the hollow tube 120. In such cases, the hollow tube 120 may be fed into and held by the die. Pressurized fluid may then be applied to the inside of the hollow tube 120 to expand the hollow tube 120 to fill the die, thereby creating the first threaded longitudinal segment 122 and the second threaded longitudinal segment 124. By using the hydroforming process, the first threaded longitudinal segment 122 and the second threaded longitudinal segment 124 may include one or more types of threads. For example, as shown in FIG. 2, the first threaded longitudinal segment 122 and the second threaded longitudinal segment 124 may include a sharp thread type. Other types of threads, such as buttress threads and knuckle threads, will be discussed further herein. In some cases, thread types such as square threads, acme threads, worm threads, or the like, may be used. These are just examples.

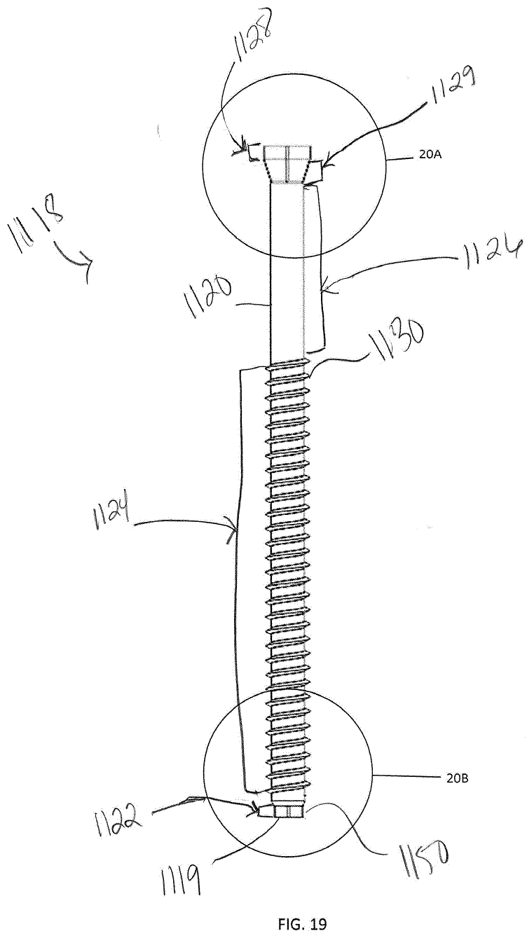

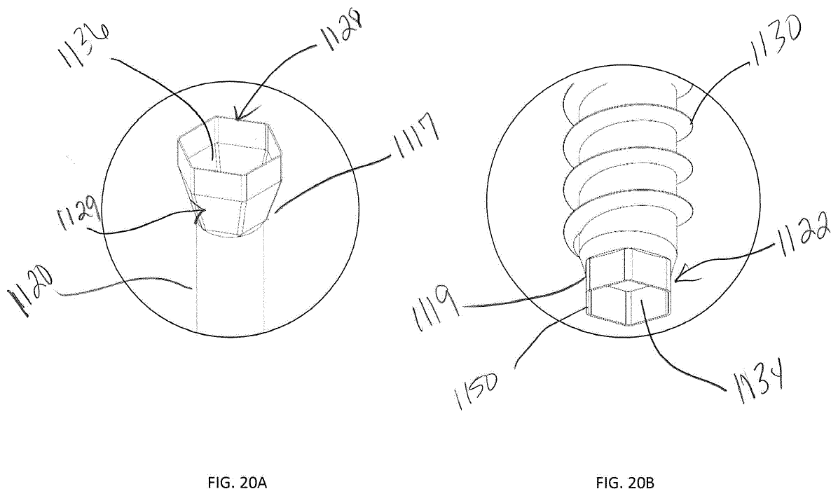

The pile 118 may include one or more drivable longitudinal segments of the hollow tube 120. As shown the one or more drivable longitudinal segments may include a first drivable longitudinal segment 128. The first drivable segment 128 may be configured to engage with an adapter which would in turn be used to drive the pile 118 into a ground surface. In such cases, the one or more drivable longitudinal segments may not overlap with the one or more threaded longitudinal segments. In some cases, the first threaded longitudinal segment 122 may be further considered to be a drivable longitudinal segment. In such cases, the one or more drivable longitudinal segments may overlap with the one or more threaded longitudinal segments. In some cases, the one or more threaded longitudinal segments may be separated longitudinally by one or more of the drivable longitudinal segments, as will be shown further with reference to FIGS. 19 to 20B.

As shown in FIG. 2, the pile 118 may further include an unthreaded longitudinal segment 126. The unthreaded longitudinal segment 126 may extend from the first end 117 of the pile 118 and does not include any of the helical segments of the one or more threaded longitudinal segments 122, 124. As shown in FIG. 2, the unthreaded longitudinal segment 126 may constitute more than one-fourth of the longitudinal length of the hollow tube 120. In other cases, the unthreaded longitudinal segment 126 may constitute less than one-fourth of the longitudinal length of the hollow tube 120.

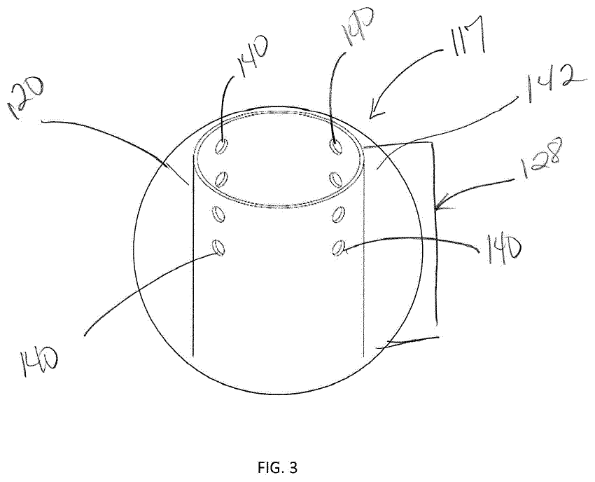

FIG. 3 is an enlarged view of the first end 117 of the pile 110 of FIG. 2, shown in Circle 3. As shown in FIG. 3, the first end 117 of the pile 118 includes the mount 142. In this embodiment, the mount 142 includes a series of one or more mounting holes 140. While it is shown that there are eight mounting holes 140, it may be contemplated that the pile 118 may include four mounting holes, six mounting holes, twelve mounting holes, twenty mounting holes, or any suitable number of mounting holes as desired. The mounting holes 140 may be used to attach solar tracking components such as for example, the bearings 22 and the drive mechanism 16, as shown in FIG. 1. In some cases, the mounting holes 140 may be configured to mount an adapter which may be used to drive the pile 118 into the ground.

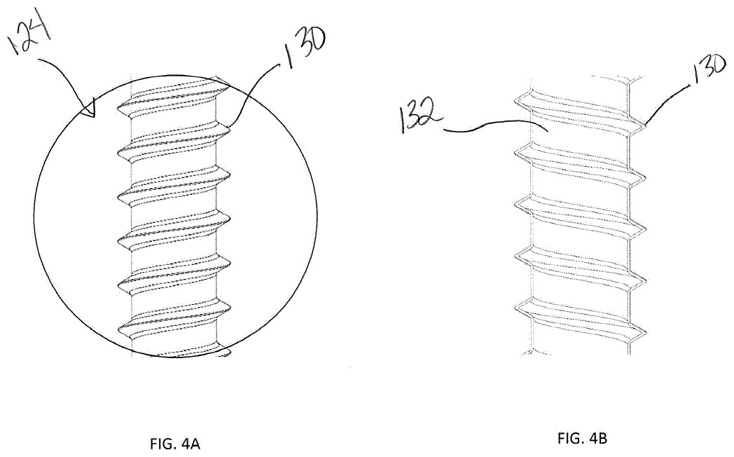

FIG. 4A is an enlarged view of the second threaded longitudinal segment 124 of the pile 118 of FIG. 2, shown in Circle 4A, and FIG. 4B is a cross-sectional view of the second threaded longitudinal segment 124 of the pile 118 as in FIG. 4A. FIG. 4A shows the helical segments 130 of the pile 118, wherein the helical segments 130 include a sharp thread. FIG. 4B illustrates the second threaded longitudinal segment bisected along a longitudinal axis of the hollow tube 120, wherein the front half has been removed. As shown, an internal surface 132 of the cross-section of the second threaded longitudinal segment 124 may be non-circular in shape as the helices of the helical segments 130 have extend in an outward direction from the longitudinal axis of the hollow tube 120. Although this may not always be the case. In some cases, the cross-section of the second threaded longitudinal segment 124 may include a circular cross-section. In other cases, the cross-section of the second threaded longitudinal segment 124 may include an oval cross-section, a polygonal cross-section, or any other suitable cross-section as desired.

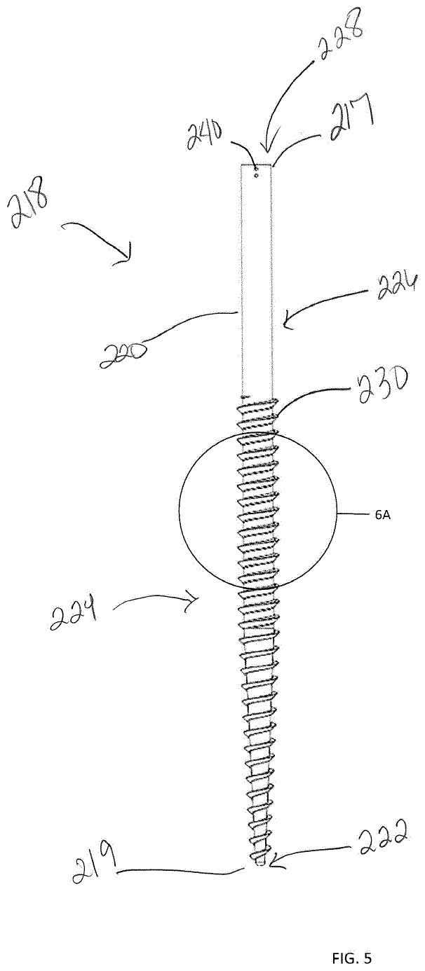

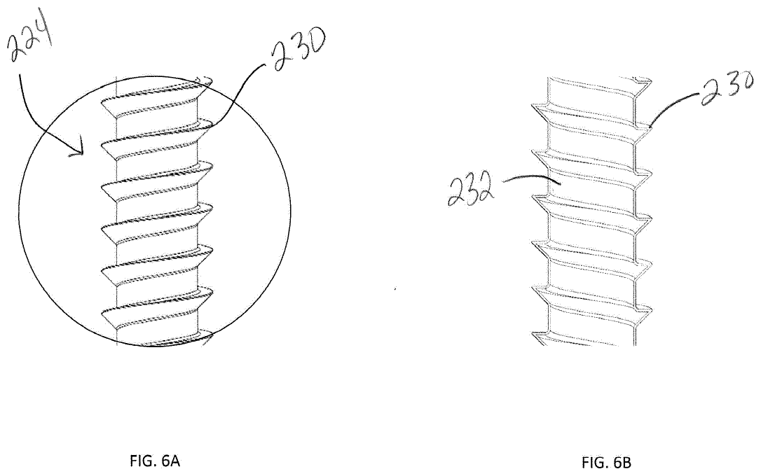

FIG. 5 is a front side view of an example ground pile 218. FIG. 6A is an enlarged view of the second threaded longitudinal segment 224 of the pile 218 of FIG. 5, shown in Circle 6A, and FIG. 6B is a cross-sectional view of the second threaded longitudinal segment 224 of the pile 218 as in FIG. 6A. The pile 218 is like the pile 118 shown in FIGS. 2 to 4B, except for the thread type of the helical segments 230. As shown in FIGS. 5 to 6B, the thread type of the helical segments 230 may include an upward buttress thread.

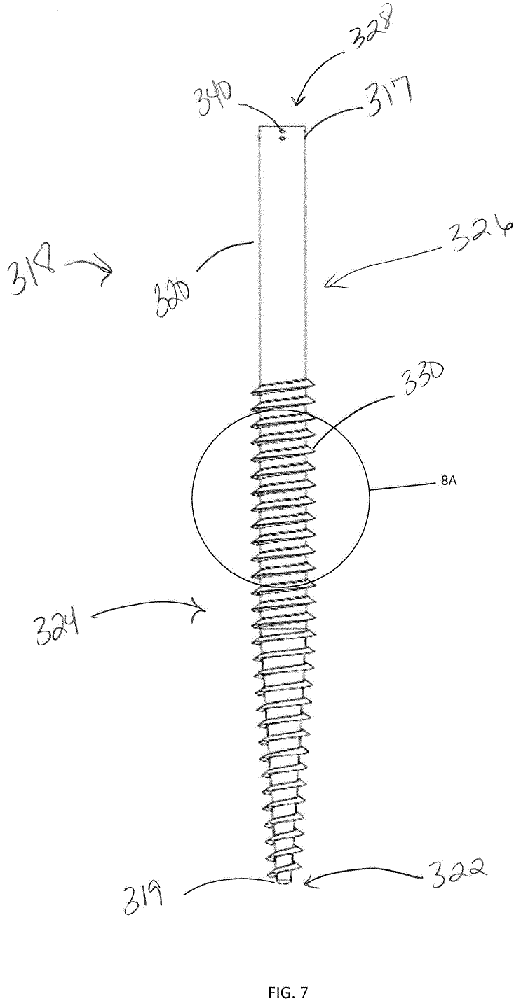

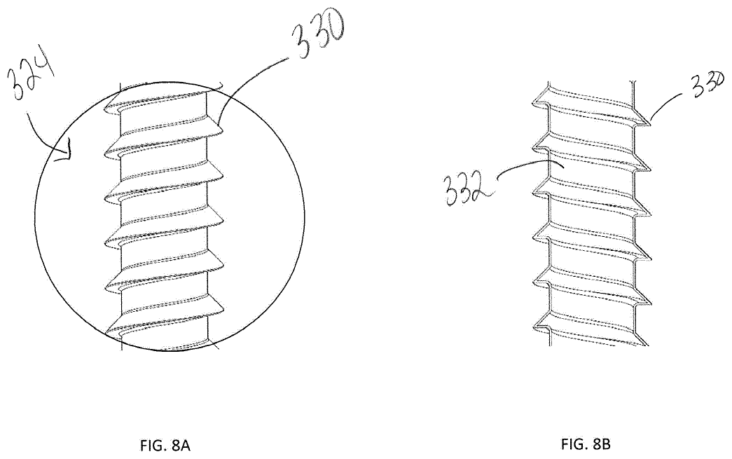

FIG. 7 is a front side view of an example ground pile 318. FIG. 8A is an enlarged view of the second threaded longitudinal segment 324 of the pile 318 of FIG. 7, shown in Circle 8A, and FIG. 8B is a cross-sectional view of the second threaded longitudinal segment 324 of the pile 318 as in FIG. 8A. The pile 318 is like the pile 118 shown in FIGS. 2 to 4B, except for the thread type of the helical segments 330. As shown in FIGS. 7 to 8B, the thread type of the helical segments 330 may include a downward buttress thread.

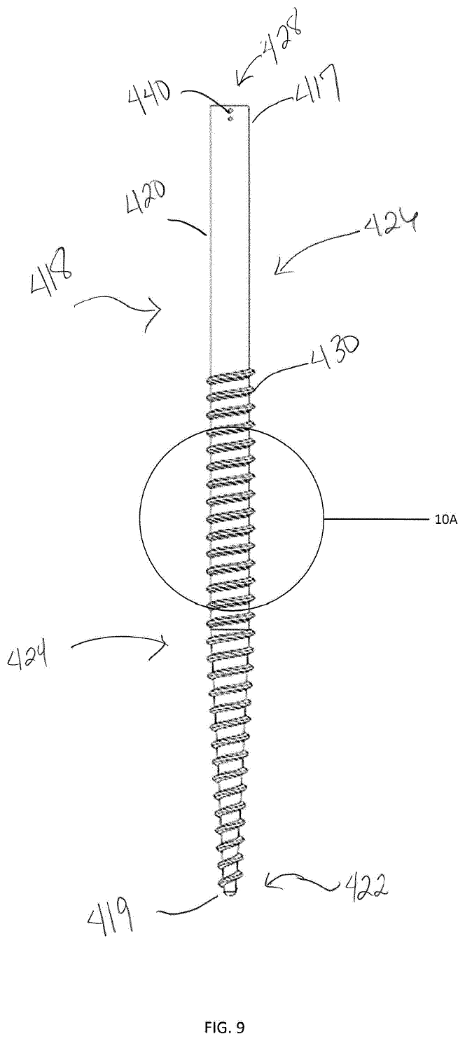

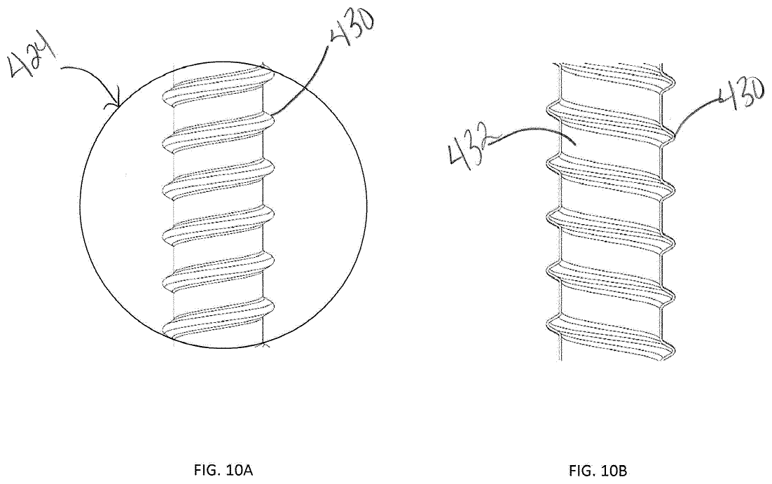

FIG. 9 is a front side view of an example ground pile 418. FIG. 10A is an enlarged view of the second threaded longitudinal segment 424 of the pile 418 of FIG. 9, shown in Circle 10A, and FIG. 10B is a cross-sectional view of the second threaded longitudinal segment 424 of the pile 418 as in FIG. 10A. The pile 418 is like the pile 118 shown in FIGS. 2 to 4B, except for the thread type of the helical segments 430. As shown in FIGS. 9 to 10B, the thread type of the helical segments 430 may include a knuckle thread.

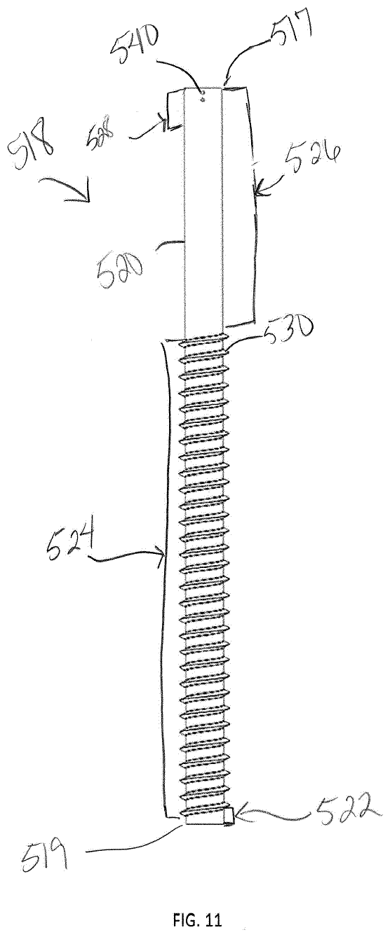

FIGS. 11 to 14 illustrate front side views of example ground piles in accordance with the present disclosure. FIG. 11 is a front side view of an example ground pile 518. The pile 518 is like the pile 118 shown in FIGS. 2 to 4B, except for the second end 519 of the hollow tube 520 includes an open end 519. In such cases, the first end 517 is open and the second end 519 is open. Further, the one or more threaded longitudinal segments 522, 524 do not taper. Rather, the first end 517 of the hollow tube 520 and the second end 519 of the hollow tube 520 include the same or a similar outer diameter.

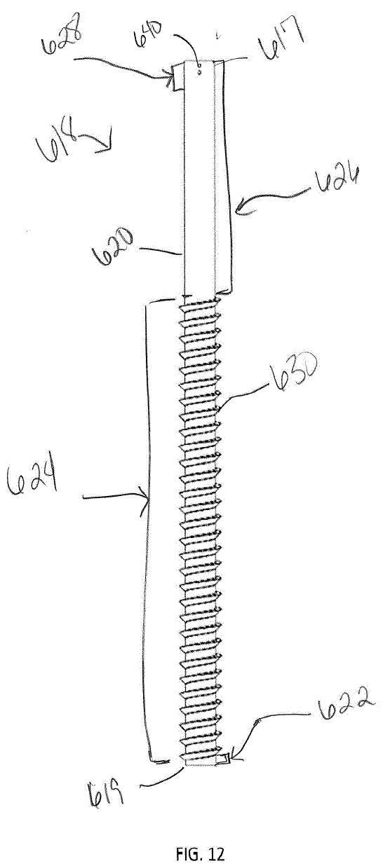

FIG. 12 is a front side view of an example ground pile 618. The pile 618 is like the pile 218 shown in FIGS. 5 to 6B, except for the second end 619 of the hollow tube 620 includes an open end 619. In such cases, the first end 617 is open and the second end 619 is open. Further, the one or more threaded longitudinal segments 622, 624 do not taper. Rather, the first end 617 of the hollow tube 620 and the second end 619 of the hollow tube 620 include the same or a similar outer diameter.

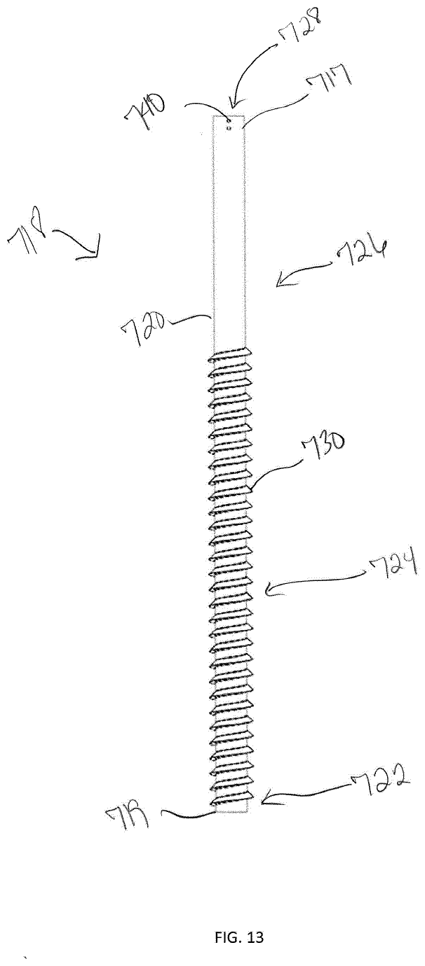

FIG. 13 is a front side view of an example ground pile 718. The pile 718 is like the pile 318 shown in FIGS. 7 to 8B, except for a second end 719 of a hollow tube 720 includes an open end 719. In such cases, a first end 717 is open and the second end 719 is open. Further, the one or more threaded longitudinal segments 722, 724 do not taper. Rather, the first end 717 of the hollow tube 720 and the second end 719 of the hollow tube 720 include the same or a similar outer diameter.

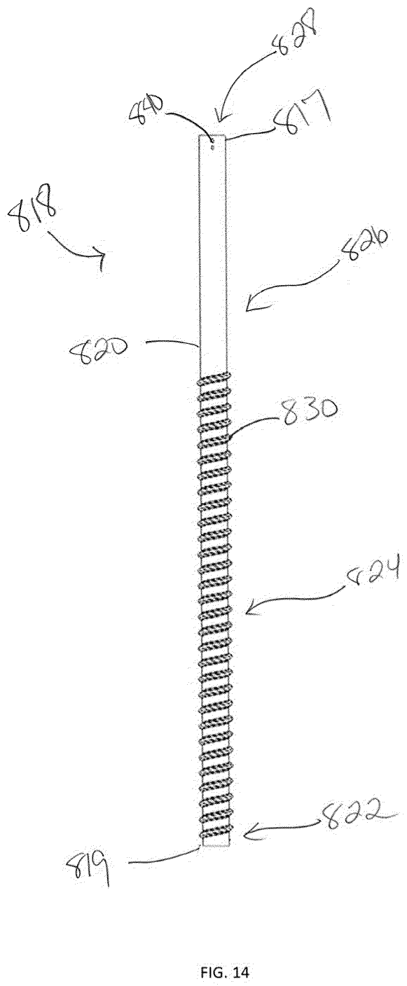

FIG. 14 is a front side view of an example ground pile 818. The pile 818 is like the pile 418 shown in FIGS. 9 to 10B, except for a second end 819 of the hollow tube 820 includes an open end 819. In such cases, the first end 817 is open and the second end 819 is open. Further, the one or more threaded longitudinal segments 822, 824 do not taper. Rather, the first end 817 of the hollow tube 820 and the second end 819 of the hollow tube 820 include the same or a similar outer diameter.

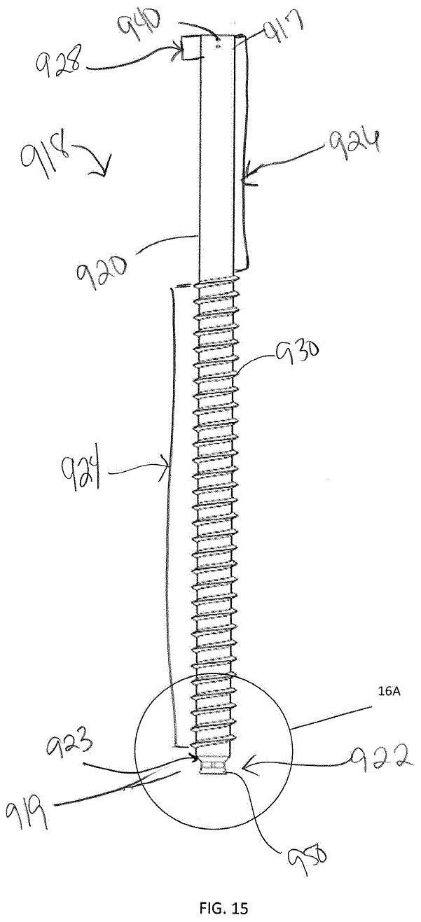

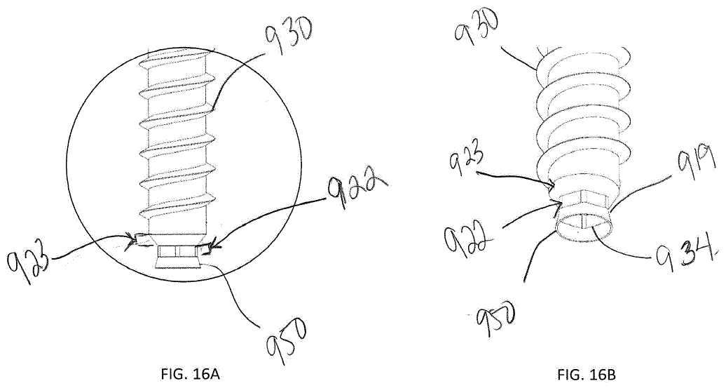

FIG. 15 is a front side view of an example ground pile 918 in accordance with the present disclosure showing a mating feature 950 at a second end 919 of the pile 918. The pile 918 is like the pile 118 shown in FIGS. 2 to 4B, except for the second end 919 of the hollow tube 920 includes the mating feature 950. The mating feature 950 may be formed from a drivable longitudinal segment 922 and a pushable longitudinal segment 923. The mating feature 950 is shown in further detail with reference to FIGS. 16A and 16B.

FIG. 16A is an enlarged view of the mating feature 950, and FIG. 16B is a bottom perspective view of the mating feature 950. As shown in FIGS. 16A and 16B, the drivable longitudinal segment 922 may include an internal surface 934 having a non-circular shape. As shown in FIG. 16B, the mating feature 950 may include an internal surface 934 having a polygonal shape. The pushable longitudinal segment 923 may further include an internal surface having a non-circular shape, but rather tapers inward from a wider cross-section to a narrower cross-section in a direction from the first end 917 towards the second end 919. While it is shown that the mating feature 950 includes an internal surface 934 having a polygonal shape, it may be contemplated that the mating feature 950 may include a triangular shape, a conical shape, an oval shape, a square shape, a rectangular shape, or any other shape as desired. In some cases, the mating feature 950 may be formed during the hydroforming process of the hollow tube 920. In some cases, the mating feature 950 may be formed via welding, wherein the mating feature 950, or drivable longitudinal segment 922, is welded onto the second end 919 of the hollow tube 920.

As previously stated, the mating feature 950 may be considered as one of the one or more drivable longitudinal segments, labeled as drivable longitudinal segment 922. The internal surface 934 of the drivable longitudinal segment 922 may be adapted to engage with a drive shaft that, when rotated, engages the internal surface 934 and rotates the pile 918 into a ground surface.

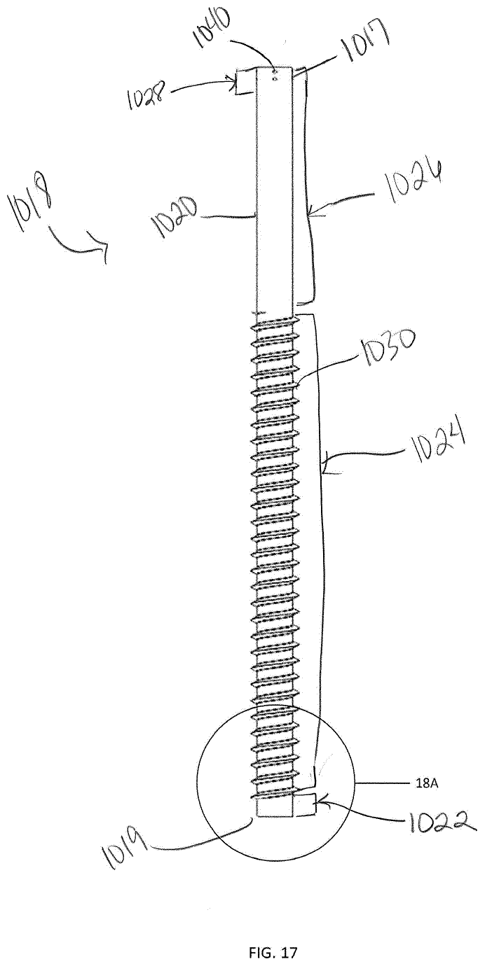

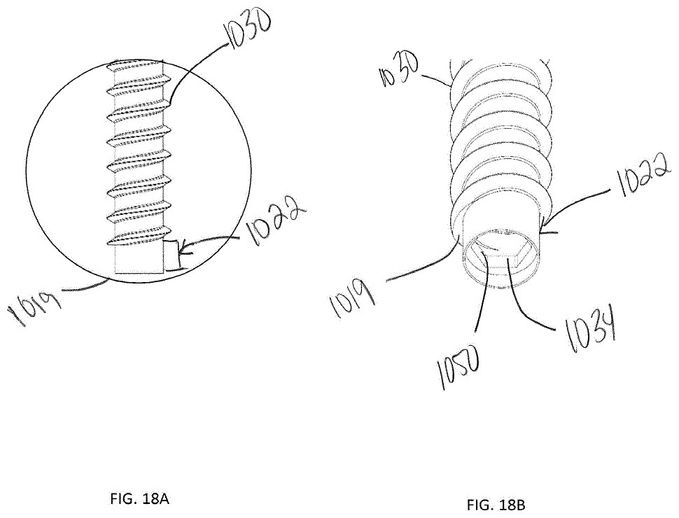

FIG. 17 is a front side view of an example ground pile 1018 in accordance with the present disclosure showing an alternative second end 1019. The pile 1018 is like the pile 118 shown in FIGS. 2 to 4B, except for the second end 1019 of the hollow tube 1020 includes a mating feature 1050 positioned within the second end 1019. The mating feature 1050 may be considered as one of the one or more drivable longitudinal segments, labeled as drivable longitudinal segment 1022. The mating feature 1050 is shown in further detail with reference to FIGS. 18A and 18B.

FIG. 18A is an enlarged view of the second end 1019, and FIG. 18B is a bottom perspective view of the second end 1019 showing an internal surface 1034 including the mating feature 1050. As shown in FIGS. 18A and 18B, the drivable longitudinal segment 1022 may include the internal surface 1034 having a non-circular shape. As shown in FIG. 18B, the internal surface 1034 may include a polygonal shape. While it is shown that the internal surface 1034 includes a polygonal shape, it may be contemplated that the internal surface 1034 may include a triangular shape, a conical shape, an oval shape, a square shape, a rectangular shape, or any other shape as desired. In some cases, the mating feature 1050, or drivable longitudinal segment 1022, may be formed during the hydroforming process of the hollow tube 1020. In some cases, the mating feature 1050 may be plug welded into the hollow tube 1020 after the hydroforming process. In some cases, the mating feature 1050 could be positioned above or below the threaded longitudinal segment 1024 along the longitudinal axis of the hollow tube 1020.

As previously stated, the mating feature 1050 may be considered as one of the one or more drivable longitudinal segments, labeled as drivable longitudinal segment 1022. The internal surface 1034 of the drivable longitudinal segment 1022 may be adapted to engage with a drive shaft that, when rotated, engages the internal surface 1034 and rotates the pile 1018 into a ground surface.

FIG. 19 is a front side view of an example ground pile 1118 in accordance with the present disclosure showing an alternative first end 1117 and an alternative second end 1119 of the pile 1118. The pile 1118 is like the pile 118 shown in FIGS. 2 to 4B, except for the second end 1119 of the hollow tube 1120 includes a mating feature 1150 positioned at the second end 1119. The mating feature 1150 may form one of the one or more drivable longitudinal segments, labeled as first drivable longitudinal segment 1122. The mating feature 1150 is shown in further detail with reference to FIGS. 20A and 20B. Further, the pile 1118 includes one or more pushable longitudinal segments 1129. The pushable longitudinal segment 1129 of the hollow tube 1120 may taper inward from a wider cross-section to a narrower cross-section in a direction from the first end 1117 toward the second end 1119. A second drivable longitudinal segment 1128 may be positioned adjacent the pushable longitudinal segment 1129. The second drivable longitudinal segment 1128 and the pushable longitudinal segment 1129 together may be considered as a mount (e.g., mount 142) located proximate the first end 1117, and may be configured to replace one or more mounting holes (e.g., mounting holes 140). In some cases, the second drivable longitudinal segment 1128 and the pushable longitudinal segment 1129 may be utilized in addition to one or more mounting holes.

FIG. 20A is an enlarged view of the first end 1117, and FIG. 20B is a bottom perspective view of the second end 1119 showing the internal surface 1134 including the mating feature 1150. As shown in FIG. 20A the second drivable longitudinal segment 1128 and the pushable longitudinal segment 1129 may include an internal surface 1136 having a non-circular shape, and shown in FIG. 20B, the first drivable longitudinal segment 1122 may include the internal surface 1134 having a non-circular shape. As shown in FIGS. 20A and 20B, the internal surface 1136 and the internal surface 1134 may include a polygonal shape. While it is shown that the internal surfaces 1134, 1136 include a polygonal shape, it may be contemplated that the internal surfaces 1134, 1136 may include a triangular shape, a conical shape, an oval shape, a square shape, a rectangular shape, or any other shape as desired. In some cases, the second drivable longitudinal segment 1128, the pushable longitudinal segment 1129, and the mating feature 1150 may be formed during the hydroforming process of the hollow tube 1120. In some cases, the second drivable longitudinal segment 1128, the pushable longitudinal segment 1129, and the mating feature 1150 may be formed via welding, wherein the mating feature 1150 is welded onto the second end 1119 of the hollow tube 1120.

As previously stated, the pushable longitudinal segment 1129 may be considered as one of the one or more pushable longitudinal segments, and the mating feature 1150 may be considered as one of the one or more drivable longitudinal segments, labeled as first drivable longitudinal segment 1122. The internal surface 1134 of the first drivable longitudinal segment 1122 and the internal surface 1136 of the pushable longitudinal segment 1140 may be adapted to engage with a drive shaft that, the drive shaft engages the internal surfaces 1134, 1136 and pushes and rotates the pile 1118 into a ground surface simultaneously.

In some cases, the mating features 950, 1050, 1150 may be configured to be positioned within an internal surface along a length of the respective hollow tubes 920, 1020, 1120. In such cases, the hollow tubes 920, 1020, 1120 may include multiple mating features 950, 1050, 1150 (e.g., four, six, eight, fifteen, twenty, etc. mating features 950, 1050, 1150) each configured to engage with a drive shaft that, when rotated, engaged internal surfaces of the mating features 950, 1050, 1150 and rotates the respective piles 918, 1018, 1118 into a ground surface. In cases where multiple mating features 950, 1050, 1150 are incorporated, the one or more drivable longitudinal segments may not overlap with the one or more threaded longitudinal segments, thereby forming a pile 918, 1018, 1118 having alternated threaded longitudinal segments.

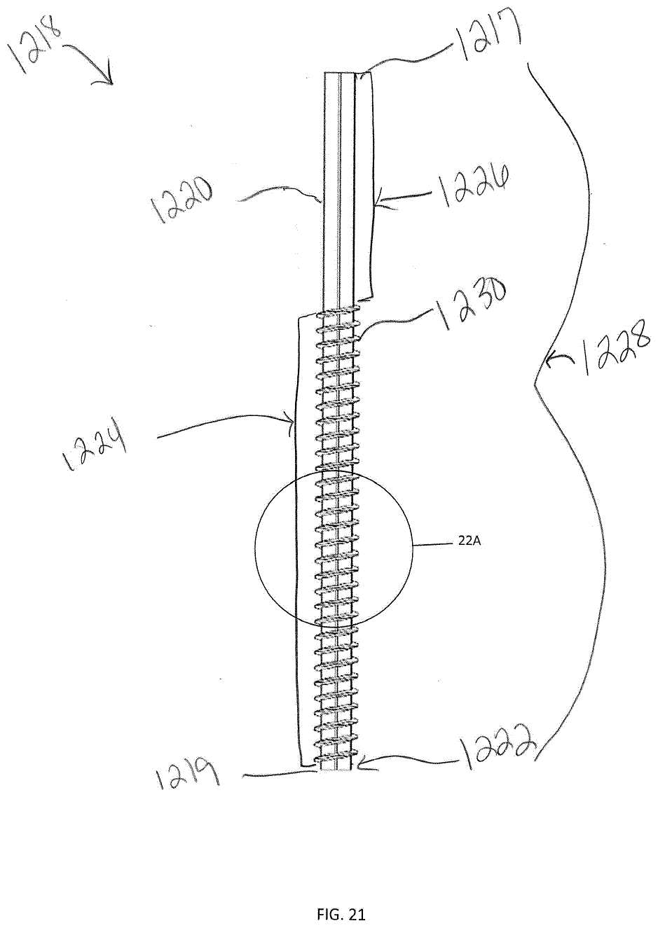

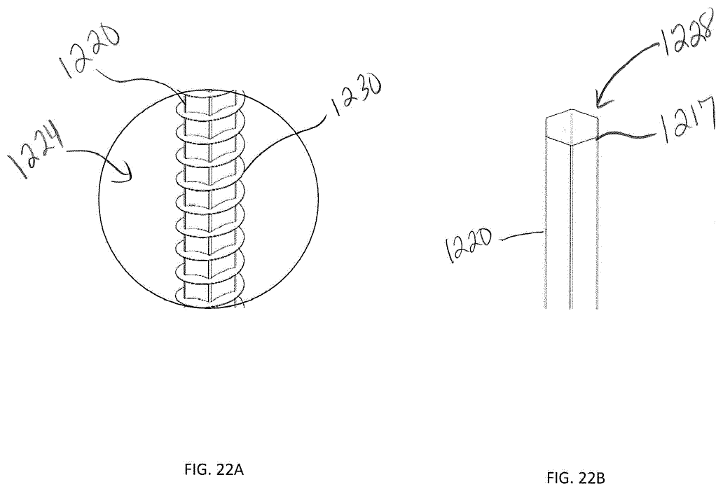

FIG. 21 is a front side view of an example ground pile 1218 in accordance with the present disclosure. FIG. 22A is an enlarged view of a second threaded longitudinal segment 1224 of the pile 1218, and FIG. 22B is a top perspective view of a first end 1217 of the pile 1218. The pile 1218 is like the pile 118 shown in FIGS. 2 to 4B, except for a hollow tube 1220 of the pile 1218 includes a hexagonal shape, as shown in FIG. 22B. Further, one or more threaded longitudinal segments 1222, 1224 include a rounded thread shape, similar to that of a sharp thread, as shown in FIG. 22A. The pile 1218 may include a threaded longitudinal segment 1224 including one or more helical segments 1230, an unthreaded longitudinal segment 1226 extending from a first end 1217 that does not have any helical segments 1230, and a drivable longitudinal segment 1228. As shown in FIG. 21, the drivable longitudinal segment 1228 overlaps longitudinally with the threaded longitudinal segment 1224 as the drivable longitudinal segment 1228 includes the entirety of the pile 1218.

While it is shown that the hollow tube 1220 of the pile 1218 includes a hexagonal shape, it may be contemplated that the hollow tube 1220 may include a square shape, a rectangular shape, a triangular shape, a W-shape, a polygonal shape, or the like.

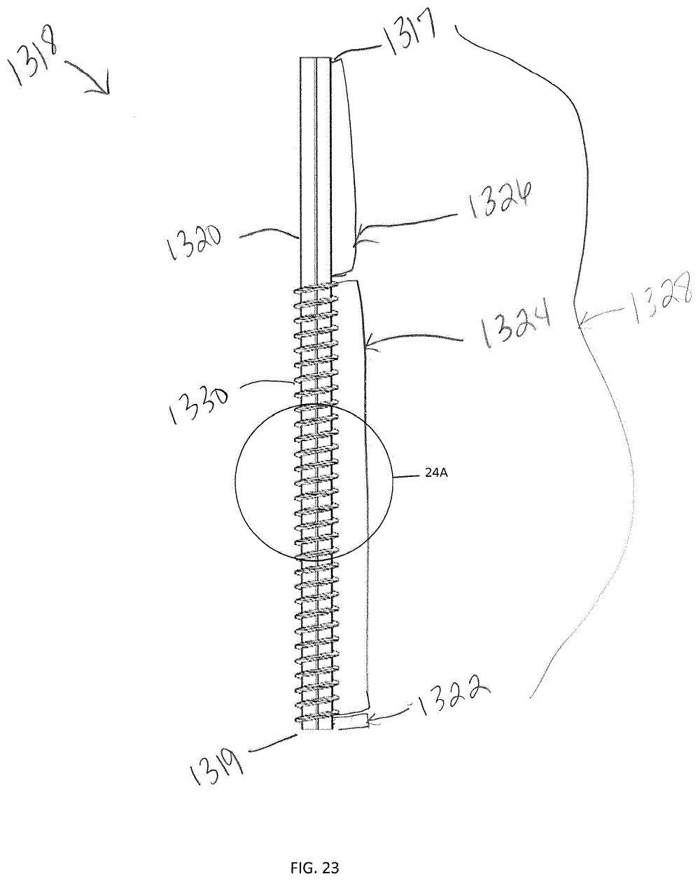

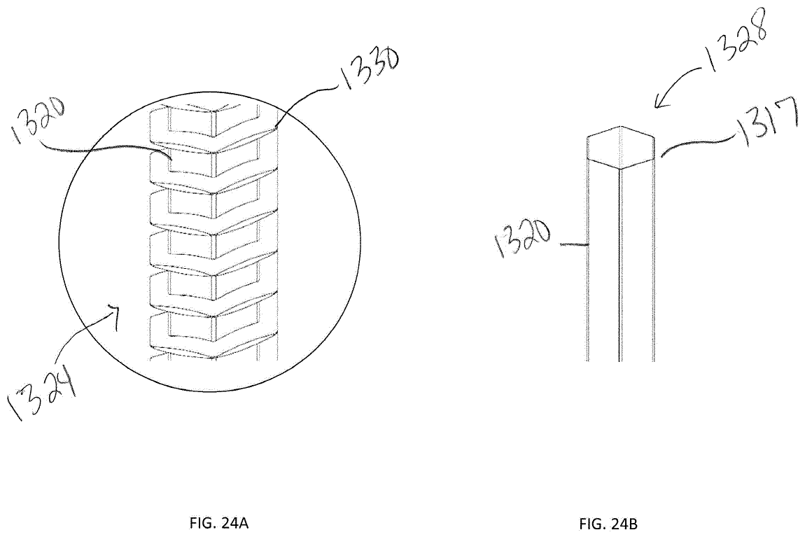

FIG. 23 is a front side view of an example ground pile 1318 in accordance with the present disclosure. FIG. 24A is an enlarged view of a threaded longitudinal segment 1324 of the pile 1318, and FIG. 24B is a top perspective view of a first end 1317 of the pile 1318. The pile 1318 is like the pile 118 shown in FIGS. 2 to 4B, except for a hollow tube 1320 of the pile 1318 includes a hexagonal shape, as shown in FIG. 24B. Further, the threaded longitudinal segment 1324 includes a helical segment 1330 having a hexagonal profile. The pile 1318 may include the threaded longitudinal segment 1324 including the one or more helical segments 1330, an unthreaded longitudinal segment 1326 extending from a first end 1317 that does not have any helical segments 1230, and a drivable longitudinal segment 1328. As shown in FIG. 23, the drivable longitudinal segment 1328 overlaps longitudinally with the threaded longitudinal segment 1324 as the drivable longitudinal segment 1328 includes the entirety of the pile 1318.

While it is shown that the hollow tube 1320 of the pile 1318 includes a hexagonal shape, it may be contemplated that the hollow tube 1320 may include a square shape, a rectangular shape, a triangular shape, a W-shape, a polygonal shape, or the like.

Various non-limiting exemplary embodiments have been described. It will be appreciated that suitable alternatives are possible without departing from the scope of the examples described herein.

What is claimed is:

1. A ground pile for a solar tracking system, comprising:
an elongate hollow tube extending longitudinally from a first end to a second end;
a mount proximate the first end for attaching solar tracking components;
one or more threaded longitudinal segments of the hollow tube each having exterior helical segments extending around the longitudinal segment and forming a screw thread; and
one or more drivable longitudinal segments of the hollow tube having cross-sections with an internal surface shaped in a non-circular shape.

2. The ground pile of claim 1, wherein the internal surface of the cross-sections of the one or more drivable longitudinal segments is polygonal shaped.

3. The ground pile of claim 1, wherein the internal surface of the cross-sections of the one or more drivable longitudinal segments is adapted to engage with a drive shaft that, when rotated, engages the internal surface and rotates the ground pile.

4. The ground pile of claim 1, wherein two of the one or more the threaded longitudinal segments are separated longitudinally by one or more of the drivable longitudinal segments.

5. The ground pile of claim 1, wherein the one or more drivable longitudinal segments do not overlap longitudinally with the one or more threaded longitudinal segments.

6. The ground pile of claim 1, wherein the one or more drivable longitudinal segments overlap longitudinally with the one or more threaded longitudinal segments.

7. The ground pile of claim 1, further comprising one or more pushable longitudinal segments of the hollow tube each tapering inward from a wider cross-section to a narrower cross-section in a direction from the first end towards the second end.

8. A ground pile for a solar tracking system, comprising:
an elongate hollow tube extending longitudinally from a first end to a second end;
a mount proximate the first end for attaching solar tracking components; and
one or more threaded longitudinal segments of the hollow tube each having exterior helical segments extending around the longitudinal segment and forming a screw thread, the helical segments of the one or more threaded longitudinal segments being formed by a hydroforming process.

9. The ground pile of claim 8, wherein the first end is open, and the second end is open.

10. The ground pile of claim 8, wherein the first end is open, and the send end is closed, and wherein a longitudinal segment of the hollow tube tapers inward towards the closed second end.

11. The ground pile of claim 8, further comprising an unthreaded longitudinal segment extending from the first end that does not have any of the helical segments of the one or more threaded longitudinal segments, the unthreaded longitudinal segment constituting more than one-fourth of the longitudinal length of the hollow tube.

12. The ground pile of claim 8, wherein the helical segments of the one or more threaded longitudinal segments are located in only two-thirds of the longitudinal portion of the hollow tube closer to the second end.

13. The ground pile of claim 8, wherein the mount includes a series of holes through the hollow tube.

14. The ground pile of claim 8, wherein the helical segments of the one or more threaded longitudinal segments are formed by a hydroforming process of a hollow tube.

15. A ground pile for a solar tracking system, comprising:
an elongate hollow tube extending longitudinally from a first end to a second end;
a mount proximate the first end for attaching solar tracking components;
one or more threaded longitudinal segments of the hollow tube each having exterior helical segments extending around the longitudinal segment and forming a screw thread; and
one or more pushable longitudinal segments of the hollow tube each tapering inward from a wider cross-section to a narrower cross-section in a direction from the first end towards the second end.

16. The ground pile of claim 15, wherein the non-circular internal surface of the cross-sections of the one or more drivable longitudinal segments are formed by a hydroforming process of a hollow tube.

17. The ground pile of claim 15, wherein the one or more drivable longitudinal segments are formed via welding to a hollow tube.

18. The ground pile of claim 15, wherein the tapering inward from a wider cross-section to a narrower cross-section in a direction from the first end towards the second end of the one or more pushable longitudinal segments are formed by a hydroforming process of a hollow tube.

19. The ground pile of claim 15, wherein the one or more drivable longitudinal segments are formed via welding to a hollow tube.

20. The ground pile of claim 15, wherein the helical segments of the one or more threaded longitudinal segments form one of sharp threads, buttress threads, or knuckle threads.
